(19) United States
(12) Patent Application Publication
(10) Pub. No.: US 2011/0167080 A1
(43) Pub. Date: Jul. 7, 2011

(54) METHOD AND APPARATUS FOR GUIDED LEARNING OF AN INFORMATION SOURCE

(75) Inventor: Christaan Henny, Groningen (NL)

(73) Assignee: eFaqt B.V., Groningen (NL)

(21) Appl. No.: 12/843,559

(22) Filed: Jul. 26, 2010

Related U.S. Application Data
(60) Provisional application No. 61/228,505, filed on Jul. 24, 2009.

(51) Int. Cl. G06F 15/16; G06F 3/01; G06F 17/30; G06Q 40/00

(52) U.S. Cl. 707/769; 715/745; 709/217; 705/39; 707/E17.014

(57) ABSTRACT

The present application discloses a method and apparatus for improving the efficiency of the learning of an information source by means of a program residing on an application computer and a plurality of databases connected to the application computer by a bus or network. The application computer is accessible to the user through a client computer connected to the application computer by a network. The program provides a customized study guidance method based on the learning preferences of the user. The present application further discloses a method for sharing learning assistance tools between users. The users can access a database of learning assistance tools prepared by other users through the interface provided by the application computer.

### TECHNICAL FIELD

The present application is generally directed to a method and apparatus for improving the efficiency of the learning of an information source.

### BRIEF SUMMARY

The present application discloses a method and apparatus for improving the efficiency of the learning of an information source. The method begins with creating a user profile wherein the user profile comprises the learning preferences of a user. The user profile is stored in one or more of a plurality of databases, wherein the plurality of databases are accessible to the application computer. Next, the appearance and presentation of the program, as displayed to the user at the client computer, are customized based on the user profile. A plurality of learning assistance tools derived from the content of the information source are provided to the application computer from the user via the client computer. The plurality of learning assistance tools are stored in one of the plurality of databases. The application computer can then utilize the learning assistance tools facilitate a user review of the information source.

The present application further discloses a method and apparatus for improving the efficiency of learning of an information source by means of a program residing on an application computer and a plurality of databases connected to the application computer by a first network, the application computer accessible to the user through a client computer connected to the application computer by a second network. The method begins with creating a user profile wherein the user profile comprises the learning preferences of a user. The user profile is stored in one or more of a plurality of databases, wherein the plurality of databases are accessible to the application computer. Next, the appearance and presentation of the program, as displayed to the user at the client computer, are customized based on the user profile. One or more learning assistance tools derived from the content of the information source are received from at least one of the plurality of databases. The application computer can then utilize the learning assistance tools to facilitate a user review of the information source.

The present application further discloses a method and apparatus for sharing learning assistance data between a first user and a plurality of secondary users. The method comprises receiving learning assistance data at an application computer from the first user located at a first client computer, the first client computer connected to the application computer by a communications network, wherein the learning assistance data is derived from an information source. The method further comprises storing the learning assistance data in a learning assistance database connected to the application computer. Then, the application computer receives a request to access the learning assistance data from a second user located at a second client computer connected to the application computer by the communications network, wherein the second user is a member of the plurality of secondary users. The application computer then transmits the learning assistance data to the second client computer over the communications network. The application computer further receives a request to access the learning assistance data at the application computer from a third user located at a third client computer connected to the application computer by the communications network, wherein the third user is a member of the plurality of secondary users. The method further comprises transmitting the learning assistance data from the application computer to the third client computer over the communications network.

The present application further discloses a system that provides for the sharing of learning assistance data between a first client computer and a second client computer over a communications network, the system comprising the first client computer operable to transmit learning assistance data over the communications network, wherein the learning assistance data is derived from the content of one or more information sources. The system further comprises the second client computer operable to transmit a request for learning assistance data over the communications network. And the system comprises an application computer connected to the first and second client computers by the communications network, wherein the application computer receives the learning assistance data from the first client computer and responds to the request from the second client computer by transmitting the learning assistance data to the second client computer over the communications network.

### BRIEF DESCRIPTION OF THE DRAWINGS

For a more complete understanding of the features and advantages of the present application, reference is now made to the detailed description along with the accompanying figures in which:

FIG. 1 is a network architecture diagram according to one aspect of the invention;

FIG. 2 is a process flow diagram according to one aspect of the invention;

FIG. 3 is a process flow diagram according to one aspect of the invention.

### DETAILED DESCRIPTION

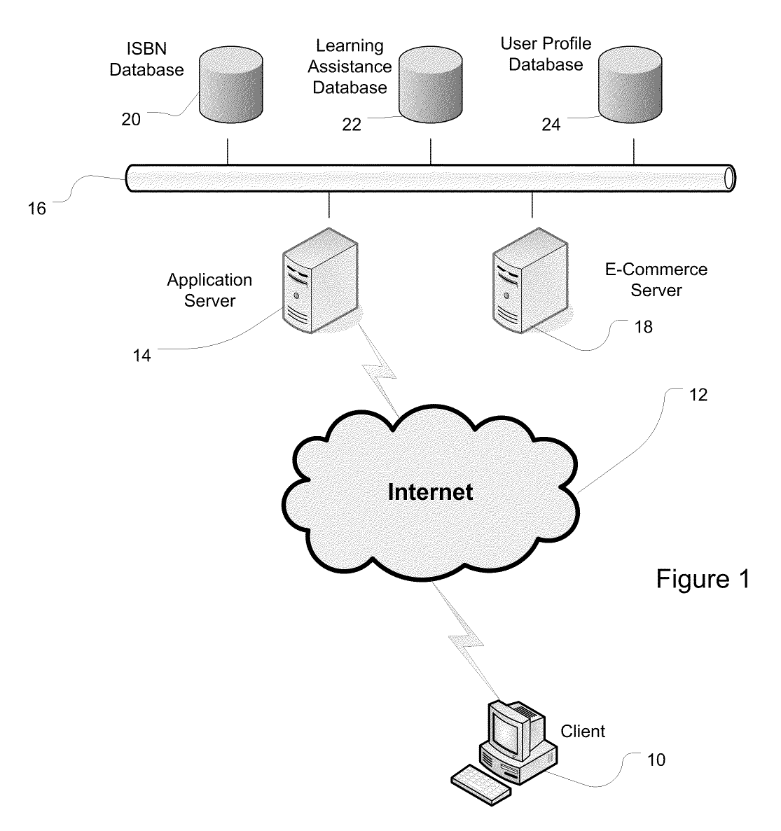

FIG. 1 illustrates an embodiment of a computer system that may implement the disclosed method. A user utilizes a client computer 10 that is connected to a network such as the Internet 12. The application server 14 is also connected to the Internet 12 and therefore can communicate with client computer 10. The application program described in the disclosed method resides on and is executed by the application server 14. The application server 14 is connected to a network 16 such as a local area network (LAN) or a wide area network (WAN) that is also connected to a plurality of databases. In some embodiments an e-commerce server 18 is also connected to the application server by the network 16. In some embodiments the plurality of databases connected to the network 16 will include an International Standard Book Number (ISBN) database 20, a Learning Assistance database 22, and a User Profile database 24. In other embodiments one or more of the plurality of databases may be co-located with the application server 14. Additionally, other embodiments may combine the application server 14 and the e-commerce server 18 into one server capable of performing both functions. In some embodiments one or more of the plurality of databases may be connected to the application server 14 by a network other than a LAN or WAN, such as the Internet.

To begin using the application program, the user would access the application server 14 by using the client computer 10. According to one embodiment, this may be done using a web browser and a secure Internet connection. The user initially sets up a user profile that is stored in the User Profile database 24. The user profile will comprise the user's personal learning preferences. These preferences can include whether the user is right-handed or left-handed. Based on this preference, the display screen layout at the client computer 10 will be oriented to properly engage the right and left hemispheres of the user's brain. Another preference that can be included in the user's profile is the timing of study periods and breaks. It is important for the user to take breaks and periodically distance himself from the subject matter. For example, the user can set a preference for a 50 minute study period, followed by a 10 minute break and then a 10 minute review period. Establishing the proper rhythm is important to the user's ability to obtain optimal efficiency in learning and retaining the content being studied. These user preferences are given by example only and are not limiting in scope of the user preferences available to be implemented by the application program.

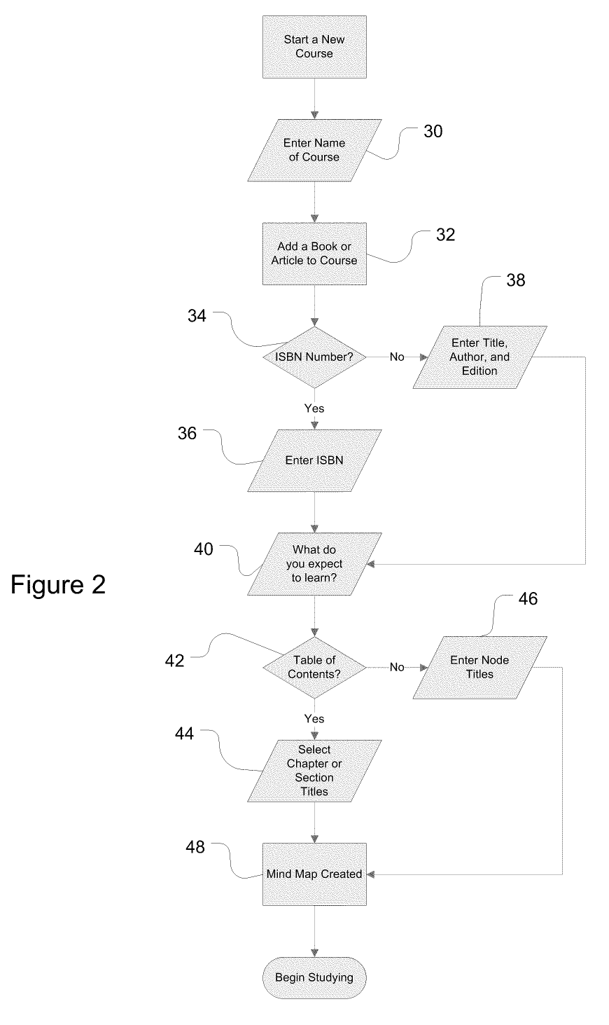

FIG. 2 is a flowchart that illustrates a portion of the process flow of one embodiment of the method disclosed by the application. In particular, FIG. 2 illustrates the method used to start a new course of study in the application program. In this embodiment, the user would start a new course of study by entering the name of the course into the application program (30) via the client computer 10. Next, the user will be prompted by the application program to add an information source, such as a book or article, to the course (32). If there is an International Standard Book Number (ISBN) associated with the book (34), the user can enter the ISBN into the application program. The ISBN is then sent from the client computer 10 to the application server 14. The application server 14 will query the ISBN database 20 and if located, the ISBN database will return the Title, Author, and Edition information to the application server 14. If no ISBN is available, the user is prompted by the application program to enter the title, author, and edition of the book (38).

The user is then prompted by the application program to contemplate and input what the user expects the learn from the information source (40). This forces the user to examine the information source at a high-level before beginning a more in-depth study process. This has the effect of activating the brain and creating an awareness of what the user will soon be studying.

The user is then prompted by the application program to input the structure of the information source. If the information source contains a table of contents (42), the user is prompted to input the chapter titles or section titles as listed in the table of contents (44). If the information source does not contain a table of contents, the user is prompted to input a collection of node names that describe the structure of the information source (46). By example, the node names can be paragraph headings, section titles, or keyword descriptions of a chapter, section, or paragraph of the information source.

Next, the application program uses the chapter titles or node names input by the user to create a preliminary mind map (48). A mind map is a tool used to visualize information. The advantage of mind mapping an information source is that it engages both cerebral hemispheres of the brain. This increases the speed and quality of learning achieved. A mind map incorporates colors and images to stimulate the right cerebral hemisphere, while providing a logical linking of elements that appeals to the left cerebral hemisphere. The application program will allow the user to print the mind map for review away from a computer.

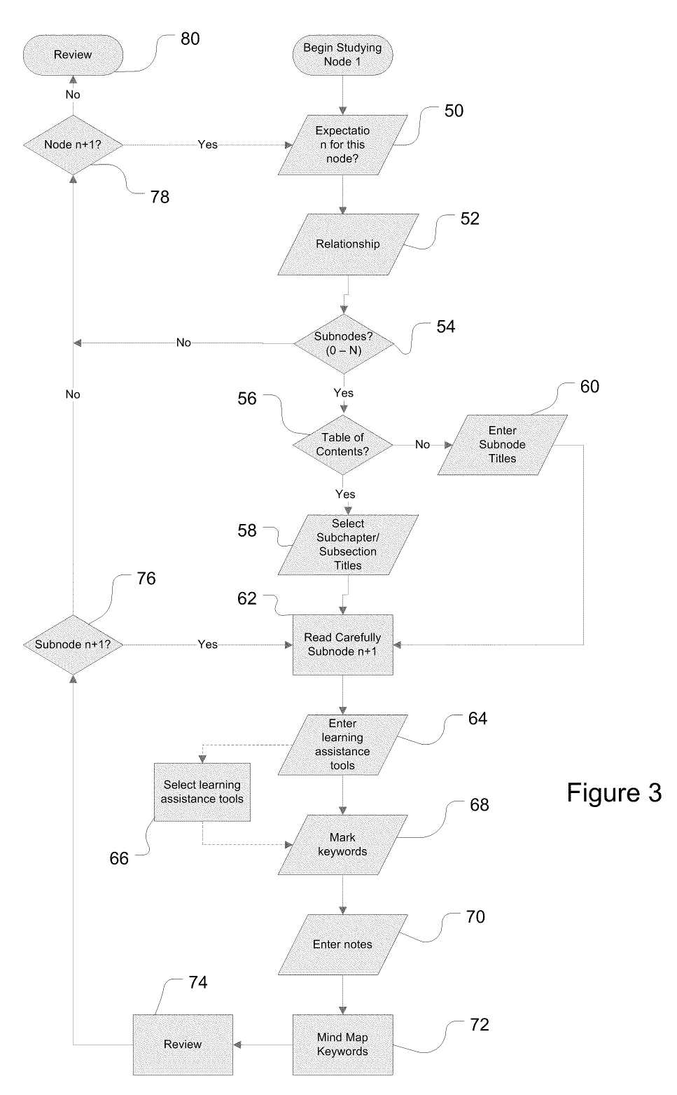

Once the preliminary mind map is created, the application will proceed to guide the user through a more in-depth learning process. This process is illustrated with the flowchart in FIG. 3. The user begins studying a first node, where the first node can be a chapter, a paragraph, a section, or any subdivision of an information source. The user is first prompted by the application program to input the user's expectations for what will be learned from this node (50). As explained previously, this forces the user to examine the node at a high-level before beginning a more in-depth study process. This has the effect of activating the brain and creating an awareness of what the user will soon be studying.

Next the program will prompt the user to input the relationship between this node and the information source (52). For example, is the node a chapter from a book, or a section from an article? This has the advantage of forcing the user to put the node in the context of the framework of the entire information source. This helps create the mental connections that contribute to effective learning.

The user is then given the option to further divide the learning of the node into subnodes (54). The subnodes can be subchapters, subsections, paragraphs, or any other logical division of the node. If the information source includes a table of contents (56) with such subdivisions, the user is prompted to enter the subchapter titles or subsection titles for the particular chapter or section that is currently being studied (58). If there is no table of contents or the table of contents does not include any such subdivisions, the user can input their own subnode names (60). Once the user has entered a subnode names, they would be prompted to enter the relationship between that subnode and any other node previously entered.

Once the structure of the subnodes is input into the application program, the user proceeds to read carefully the first subnode (62). If no subnodes exist, the user will read the entire node. Once the user has completed the reading, the application program prompts the user to formulate a series learning assistance tools. These learning assistance tools will help the user to review the contents of the reading at a later time. By example, the learning assistance tools could be notes on the reading, a summary of the reading, an outline of the reading, or a series of questions and answers on important subject matter from the reading. The user inputs these learning assistance tools into the program (64). By formulating learning assistance tools from the text, the user is compelled to obtain a true understanding of the content. Additionally, it assists the user in separating the main ideas of the reading from side issues or information of lesser importance.

In some embodiments, instead of inputting their own learning assistance tools, the user will have the option to select learning assistance tools (66) from a Learning Assistance database 22. If there are already learning assistance tools stored in the database 22 that correspond to the information source being studied by the user, the application program displays a listing of such learning assistance tools and gives the user the option to select them for their personal use in studying. In such embodiments, if the user chooses to input their own learning assistance tools, those learning assistance tools will be stored in the Learning Assistance database 22 for future use by other users who are studying the same information source.

In other embodiments, a payment and compensation scheme is implemented for access to the stored learning assistance tools. In such embodiments, each user will establish an account that is maintained by the e-commerce server 18. A user can load a value into the account through various payment methods, including but not limited to credit card transactions, debit card transactions, bank transfers, and online payment services such as PayPal®. A first user is defined as the user who submits a learning assistance tool to be stored in the Learning Assistance database 22. A second user wishing to access the stored learning assistance tool will submit a request for payment that is sent to the e-commerce server 18. The e-commerce server 18 will check the second user's account balance and if a sufficient balance is determined to exist, a first payment amount is subtracted from the second user's account balance and notification of a successful transaction is sent from the e-commerce server 18 to the application server 14. The application server 14 then grants the second user access to that particular learning assistance tool. If the account balance of the second user's account is determined by the e-commerce server 18 to have an insufficient account balance, the transaction is denied and the application server 14 will deny the second user access to the stored learning assistance tool. Subsequent to a successful purchase by the second user, the e-commerce server 18 will then credit the first user's account with a first compensation amount in exchange for the access by the second user. For every additional user that purchases access to the first user's stored learning assistance tool, the value of the learning assistance tool is increased and therefore, the payment amount and compensation amounts are increased. By way of example, if a third user wishes to access the first user's stored learning assistance tool after the second user has already purchased access to the same learning assistance tool, the third user's account will be debited by a second payment amount which is greater than the first payment amount. Additionally, the first user's account will then be credited with a second compensation amount after the third user's purchase of the learning assistance tool, where the second compensation amount is greater than the first compensation amount. The value of a stored learning assistance tool may be limited to a maximum value such that once this maximum value is reached, any subsequent accesses to the stored learning assistance tool will be associated with a maximum payment amount and a maximum compensation amount. According to one embodiment, the cost of the learning assistance tool and the compensation given to the first user will double with each purchase (i.e. 1, 2, 4, 8, 16) until a maximum value of 16 is reached.

Referring back to FIG. 3, once a user has either input one or more learning assistance tools or selected stored learning assistance tools for the subnode based on the methods described above, one embodiment of the application program prompts the user to select keywords from the learning assistance tools for the subnode (68). By selecting keywords, the user is compelled to take a critical look again at the learning assistance tools chosen previously. Next in the process, the user is given the opportunity to input any additional notes (70) that they may want to include for that particular subnode.

The application program then uses the keywords selected by the user in block 68 to further populate the mind map (72) constructed in block 48. This helps fill the visual learning tool with the important concepts deduced from the careful reading of the subnode. Once this process is complete, the application program reviews the content of the subnode with the user (74) through the use of the learning assistance tools and the keywords selected by the user. For example, one embodiment may review the content of the subnode by presenting the question/answer set selected by the user with the keywords left blank. The user then inputs the keywords in the appropriate blanks and the application moves on to the next question when the response is correct. This form of review can also be performed with any of the other forms of learning assistance tools such as notes, summaries, or outlines. This once again reinforces the main ideas and keywords chosen by the user to be the important concepts that are crucial to learning the content of the subnode. A review of the information source can be requested at anytime during the study process. At the time of such a request, the review would be based on the information thus far collected from the user.

Once the review is complete, the user then moves on to the next subnode if such a subnode exists (76). If there is another subnode to be studied in the current node, the user will repeat the same process for the subsequent subnode, starting with reading the subnode carefully (62). If there is not another subnode within the current node, the next step would be to start studying the next node if one exists (78). This process would begin with a prompt from the application program as to the user's expectations of what will be learned from this node (50). The process then proceeds as it did for the previous node studied. Nodes and subnodes of an information source do not have to be studied in any particular order. The user can select which node or subnode to proceed to next regardless of the order they appear in the information source.

If the studying of all nodes and subnodes has been completed, the application program will prompt the user to review all of the materials studied in the information source. This comprises reviewing all learning assistance tools selected by the user from all nodes and subnodes and is depicted by block 80 in FIG. 3. The application will use a number of methods to review the content with the user. By example, the application program may leave out parts of sentences, make errors in sentences by placing incorrect keywords, or creating multiple choice questions for the user to answer.

In some embodiments, the user will be asked to complete a series of tests before beginning a course of study. These tests are used to determine the learning style and capabilities of the user. The results of such tests will be stored in the user's profile on the User Profile database 24. One example of such a test is the Kolb Test developed by Professor David Kolb. The Kolb Test can be used to determine during which phase of learning that a particular user achieves the best learning experience. In some embodiments, the application program will utilize the results of the Kolb test to further customize the learning environment presented to the user such that it better fits the user's learning style. Another example of a test that can be presented to the user is the Visual-Auditory-Kinesthetic (VAK) learning styles test. This test determines which sensory organ a user responds best to when assimilating information. In some embodiments the application program will utilize the results of this test to adapt the learning environment presented to the user to better fit the user's learning style. By example, the application program could adapt the language with which the program communicates to the user to appeal to a user's preferred senses. This could mean using special words or auditory commands that appeal to a particular sense.

In some embodiments, the program will implement the suggestopedic methods as developed by Professor Georgi Lozanov. Professor Lozanov has determined that when the neurons in a person's brain are stimulated at a frequency between 7 and 14 Hz (7.83 Hz being optimal), the student can assimilate information much faster and finds it easy to concentrate while remaining relaxed. This status, known as “alpha status” can be brought about by providing sensory stimulation at this frequency in a person's surroundings. The application program can implement this by causing a display screen at the client computer 10 to flicker at a frequency in the 7 to 14 Hz range. Additionally, the application program can play music at the proper frequency, such as baroque music, that can help put the user into alpha status.

In some embodiments, the application program will schedule the study times for the user and send a message to the user when a scheduled study time is approaching or has arrived. The messages can be sent by a method such as email, SMS message, instant message, or a pop-up on a computer screen. Additionally the user will be able to sync the study schedule maintained by the application program with other organizer software such as a PDA or Microsoft Outlook™ calendar.

In some embodiments, the application program will enable a user to chat with other users via an online chat client or an online forum. This will allow users studying the same course to have conversations on the material and promote sharing of ideas.

It should be appreciated that the breadth and scope of the invention(s) should not be limited by any of the above-described exemplary embodiments, but should be defined only in accordance with the following claims and their equivalents. Moreover, the above advantages and features are provided in described embodiments, but shall not limit the application of the claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” the claims should not be limited by the language chosen under this heading to describe the so-called technical field. Further, a description of a technology in the “Background” is not to be construed as an admission that technology is prior art to any invention(s) in this disclosure. Neither is the “Brief Summary” to be considered as a characterization of the invention(s) set forth in the claims found herein. Furthermore, any reference in this disclosure to “invention” in the singular should not be used to argue that there is only a single point of novelty claimed in this disclosure. Multiple inventions may be set forth according to the limitations of the multiple claims associated with this disclosure, and the claims accordingly define the invention(s), and their equivalents, that are protected thereby. In all instances, the scope of the claims shall be considered on their own merits in light of the specification, but should not be constrained by the headings set forth herein.

What is claimed is:

1. A computer system-implemented method for improving the efficiency of learning an information source wherein the method comprises the steps of:
communicating with an application computer from a client computer, wherein the application computer and the client computer are connected to each other through a communications network;
creating a user profile wherein the user profile comprises the learning preferences of a user;
storing the user profile in one or more of a plurality of databases, wherein the plurality of databases are accessible to the application computer;
utilizing the contents of the user profile to customize the appearance and presentation of an application program displayed at the client computer;
receiving from the client computer a plurality of learning assistance tools derived from the content of the information source;
storing the plurality of learning assistance tools in one or more of the plurality of databases; and
utilizing the learning assistance tools to facilitate a user review of the information source.

2. The method of claim 1 further comprising the steps of:
receiving from the client computer one or more keywords derived from the content of the information source;
utilizing the one or more keywords to construct a mind map;
displaying the mind map at the client computer;
utilizing the one or more keywords and the mind map to further facilitate the user review of the information source.

3. The method of claim 1 further comprising the steps of:
receiving from the client computer a plurality of node names corresponding to the content of an information source;
utilizing the node names to construct a mind map;
displaying the mind map at the client computer;
utilizing the mind map to further facilitate the user review of the information source.

4. The method of claim 3 wherein the plurality of node names are comprised of chapter titles, section titles, paragraph headings, or keyword descriptions.

5. The method of claim 3 further comprising the steps of:
receiving from the client computer the relationships between the plurality of node names and the information source;
utilizing the relationships to construct the mind map.

6. The method of claim 1 further comprising the step of:
receiving from the client computer the learning expectations associated with the information source or a particular node.

7. The method of claim 1 wherein the communications network is the Internet.

8. The method of claim 1 further comprising the step of:
providing a secure communications link between the application computer and the client computer by encrypting the data sent over the communications network.

9. The method of claim 1 further comprising the step of:
receiving from the client computer identifying information associated with the information source.

10. The method of claim 7 wherein the identifying information is an International Standard Book Number (ISBN).

11. The method of claim 10 further comprising the step of:
sending the International Standard Book Number (ISBN) to an ISBN database;
querying the ISBN database for a matching International Standard Book Number entry;
receiving at least the title and author of the information source from the ISBN database.

12. The method of claim 1 wherein the plurality of learning assistance tools are comprised of notes, summaries, outlines, or question and answer sets.

13. The method of claim 1 further comprising the step of:
sending a message to the user based on the content of the user profile associated with that user.

14. The method of claim 13 wherein the message is in the form of an e-mail, instant message, SMS text message, or a pop-up window on the client computer.

15. A computer system-implemented method for improving the efficiency of learning an information source wherein the method comprises the steps of:
communicating with an application computer from a client computer, wherein the application computer and the client computer are connected to each other through a communications network;
creating a user profile and storing the user profile in one or more of a plurality of databases, wherein the plurality of databases are accessible to the application computer;
utilizing the contents of the user profile to customize the appearance and presentation of an application program displayed at the client computer;
receiving from at least one of the plurality of databases one or more learning assistance tools associated with the information source; and
utilizing the one or more learning assistance tools to facilitate a user review of the information source.

16. The method of claim 15 further comprising the steps of:
receiving from the client computer one or more keywords derived from the content of the information source;
utilizing the one or more keywords to construct a mind map;
displaying the mind map at the client computer;
utilizing the one or more keywords and the mind map to further facilitate the user review of the information source.

17. The method of claim 16 further comprising the steps of:
receiving from the client computer a plurality of node names corresponding to the content of an information source;
utilizing the node names to construct a mind map;
displaying the mind map at the client computer;
utilizing the mind map to further facilitate the user review of the information source.

18. The method of claim 17 wherein the plurality of node names are comprised of chapter titles, section titles, paragraph headings, or keyword descriptions.

19. The method of claim 17 further comprising the steps of:
receiving from the client computer the relationships between the plurality of node names and the information source;
utilizing the relationships to construct the mind map.

20. The method of claim 15 further comprising the step of:
receiving from the client computer the learning expectations associated with the information source or a particular node.

21. The method of claim 15 wherein the communications network is the Internet.

22. The method of claim 15 further comprising the step of:
providing a secure communications link between the application computer and the client computer by encrypting the data sent over the communications network.

23. The method of claim 15 further comprising the step of:
receiving from the client computer identifying information associated with the information source.

24. The method of claim 23 wherein the identifying information is an International Standard Book Number (ISBN).

25. The method of claim 24 further comprising the step of:
sending the International Standard Book Number (ISBN) to an ISBN database;
querying the ISBN database for a matching International Standard Book Number entry;
receiving at least the title and author of the information source from the ISBN database.

26. The method of claim 15 wherein the plurality of learning assistance tools are comprised of notes, summaries, outlines, or question and answer sets.

27. The method of claim 15 further comprising the step of:
sending a message to the user based on the content of the user profile associated with that user.

28. The method of claim 27 wherein the message is in the form of an e-mail, instant message, SMS text message, or a pop-up window on the client computer.

29. A computer system-implemented method for sharing learning assistance data between a first user and a plurality of secondary users, wherein the method comprises:
receiving learning assistance data at an application computer from the first user located at a first client computer, the first client computer connected to the application computer by a communications network, wherein the learning assistance data is derived from an information source;
storing the learning assistance data in a learning assistance database connected to the application computer;
receiving a request to access the learning assistance data at the application computer from a second user located at a second client computer connected to the application computer by the communications network, wherein the second user is a member of the plurality of secondary users;
transmitting the learning assistance data from the application computer to the second client computer over the communications network;
receiving a request to access the learning assistance data at the application computer from a third user located at a third client computer connected to the application computer by the communications network, wherein the third user is a member of the plurality of secondary users;
transmitting the learning assistance data from the application computer to the third client computer over the communications network.

30. The method of claim 29 further comprising the steps of:
receiving a payment at the application computer of a first payment amount by the second user from the second client computer in exchange for the right to access the learning assistance data from the learning assistance database;
verifying an account balance in a first account associated with the second user;
transferring a first compensation amount from the first account associated with the second user to a second account associated with the first user;
receiving a request for payment at the application computer of a second payment amount by the third user from the third client computer in exchange for the right to access the shared data from the database, wherein the second payment amount is greater than the first payment amount;
verifying an account balance in a third account associated with the third user;
transferring a second compensation amount from the third account associated with the third user to the second account associated with the first user.

31. The method of claim 30 wherein the first compensation amount and the second compensation amount are determined based in part on the number of requests previously received to access the learning assistance data.

32. The method of claim 31 wherein the second compensation amount is greater than the first compensation amount.

33. The method of claim 25 or 26 wherein the communications network is the Internet.

34. The method of claim 29 or 30 further comprising the step of:
providing a secure communications link between the application computer and the first, second, and third client computers by encrypting the data sent over the communications network.

35. The method of claim 29 or 30 wherein the learning assistance data is comprised of notes, summaries, outlines, or question and answer sets.

36. A system that provides for the sharing of learning assistance data between a first client computer and a second client computer over a communications network, the system comprising:
the first client computer operable to transmit learning assistance data over the communications network, wherein the learning assistance data is derived from the content of one or more information sources;
the second client computer operable to transmit a request for learning assistance data over the communications network; and
an application computer connected to the first and second client computers by the communications network, wherein the application computer receives the learning assistance data from the first client computer and responds to the request from the second client computer by transmitting the learning assistance data to the second client computer over the communications network.

37. The method of claim 36 wherein the learning assistance data is comprised of notes, summaries, outlines, or question and answer sets.
